(19) United States
(12) Patent Application Publication
(10) Pub. No.: US 2016/0282841 A1
(43) Pub. Date: Sep. 29, 2016

(54) Parameter Setting Method for Positioning Apparatus and Positioning Apparatus

(71) Applicant: DMG MORI CO., LTD., Nara (JP)

(72) Inventors: Shinji Ishii, Nara (JP); Yuki Terada, Nara (JP)

(73) Assignee: DMG MORI CO., LTD., Nara (JP)

(21) Appl. No.: 15/070,846

(22) Filed: Mar. 15, 2016

(30) Foreign Application Priority Data
Mar. 25, 2015 (JP) 2015-061912

(51) Int. Cl. G05B 19/404; B23Q 15/013

(52) U.S. Cl. CPC G05B 19/404; B23Q 15/013; G05B 2219/50047; G05B 2219/41138

(57) ABSTRACT

A positioning apparatus includes a parameter setter for setting control parameters used by the positioning apparatus. The parameter setter executes a resonance frequency detection processing to detect a resonance frequency which occurs when a movable rest having an object to be moved attached thereto is moved and an inertia estimation processing to estimate an inertia which acts on the movable rest when the movable rest having the object to be moved attached thereto is moved, and executes a processing of setting a frequency band to be removed by a notch filter and a speed gain used in a speed controller based on the detected resonance frequency and a processing of setting a processing a rapid feed time constant based on the estimated inertia.

### BACKGROUND

1. Field of the Disclosure

The present disclosure relates to a positioning apparatus that controls positioning of a moving device rotationally or linearly moving a movable rest to which an object to be moved is attached, and a parameter setting method for setting parameters used in the positioning apparatus.

2. Background of the Disclosure

For example, in the field of machine tool, the above-described positioning apparatus has been generally used for positioning control of a feed device or a rotary table. A known example of such a positioning apparatus is disclosed in Japanese Unexamined Patent Application Publication No. 2009-101444, which controls a biaxial unit having a trunnion structures provided on a machine tool such as a 5-axis control vertical machining center. The positioning apparatus includes a function generator, a position controller, a speed controller, and a torque/current controller, and controls a motor rotating the trunnion in accordance with a signal output from the torque/current controller.

Specifically, in this positioning apparatus, a position command is generated based on an NC command output from an NC device by the function generator, a speed command is generated based on the generated position command and a position gain by the position controller, a torque command is generated based on the generated speed command and a speed gain by the speed controller, a drive torque signal is generated based on the generated torque command and a torque gain by the torque/current controller, and a current corresponding to the signal is supplied to the motor, whereby the motor is driven.

Further, the positioning apparatus has an angle error estimator provided therein which calculates an angle error caused by elastic deformation of the trunnion and compensates for the angle error; the angle error estimator calculates the angle error AO by the following equation:

Δθ=(Tm−Jm·α)/KθR,

where Jm is an inertia of the turning shaft portion or the bearing, Tm is a torque command output from the speed controller, α is a rotational angular acceleration, and KθR is a torsional rigidity coefficient.

### SUMMARY OF THE DISCLOSURE

By the way, in the above-described conventional positioning apparatus, when a position command is generated in the function generator, a rapid feed time constant is used in the case the position command is for rapid feed movement. Further, a position gain, a speed gain, and a torque gain are used in the position controller, the speed controller, and the torque/current controller, respectively. In order to achieve stable control, the control parameters such as the rapid feed time constant, the position gain, the speed gain, and the torque gain have to be set properly.

Further, although not disclosed in Japanese Unexamined Patent Application Publication No. 2009-101444, generally, a damping filter is provided between the speed controller and the torque/current controller, and the torque command output from the speed controller passes through the damping filter and thereby a vibration component in a specific frequency band is removed, and then the torque command is input into the torque/current controller. The frequency band to be removed that is set for the damping filter is also a control parameter, and this has to be set properly in order to achieve stable control.

Accordingly, the above-mentioned control parameters are hitherto determined in advance in accordance with machining specifications set for the machine tool, such as maximum size and maximum weight of workpiece, maximum machining load, etc., by the machine tool manufacturer so that appropriate machining is achieved.

However, in recent years, users have handled various workpieces having various materials and shapes, and this causes various problems in the above-described positioning control. For example, when a user machines a workpiece having a very thin thickness, a problem occurs that the workpiece vibrates when being moved and this vibration (external disturbance vibration) vibrates the positioning control system. Further, in the case where a user handles a workpiece having a weight larger than an assumed maximum weight, if the workpiece is moved with a determined rapid feed acceleration, a torque larger than assumed has to be applied to the motor. However, the control system usually has a determined torque upper limit; therefore, the motor torque reaches saturation and becomes uncontrollable and vibration such as hunting and overshoot occurs on the control system.

In order to solve these problems, at least the rapid feed time constant, the speed gain, and the frequency band to be removed by the damping filter of the above-mentioned control parameters have to be reset to proper values corresponding to the handled workpiece. However, conventionally, when these parameters are reset, there is no choice but to relying on a trail-and-error method, that is, a method in which the control parameters are changed little by little and the operation is tested. Therefore, there is a problem that the above-described problems cannot be solved quickly.

The present disclosure has been achieved in view of the above-described circumstances, an object thereof is to provide a parameter setting method for positioning apparatus which allows control parameters to be reset to proper values corresponding to a handled object quickly without using a trial-and-error method, as well as such a positioning apparatus.

The present method for solving the above-described problems relates to a parameter setting method for setting control parameters for a positioning apparatus positioning a movable rest for attaching an object to be moved thereto at a commanded target position by controlling a drive motor of a moving device rotationally or linearly moving the movable rest, the control parameters including at least control parameters for a rapid feed time constant, a speed gain, and a frequency band to be removed by damping filter, including:
executing a resonance frequency detection processing and an inertia estimation processing, the resonance frequency detection processing being executed by moving the movable rest having the object to be moved attached thereto and detecting a resonance frequency occurring on the moving device, the inertia estimation processing being executed by moving the movable rest having the object to be moved attached thereto and estimating an inertia acting on the moving device; and setting the frequency band to be removed by damping filter and the speed gain based on the detected resonance frequency and setting the rapid feed time constant based on the estimated inertia.

Further, the present apparatus relates to apparatus for positioning a movable rest for attaching an object to be moved thereto at a commanded target position by controlling a drive motor of a moving device rotationally or linearly moving the movable rest, including:
a position command generator generating a position command based on the target position and outputting the generated position command and, at least in a case of rapid feed movement, generating a position command corresponding to a rapid feed time constant and outputting the generated position command;
a position controller receiving input of the position command output from the position command generator, and generating a speed command based on the input position command and a position gain and outputting the generated speed command;
a speed controller receiving input of the speed command output from the position controller, and generating a torque command based on the input speed command and a speed gain and outputting the generated torque command;
a damping filter receiving input of the torque command output from the speed controller, and removing a component in a specific frequency band from the input torque command and then outputting the torque command; and
a torque controller receiving input of the torque command output from the damping filter, and generating a drive torque signal for the drive motor based on the input torque command and a torque gain and outputting the generated drive torque signal;
the positioning apparatus further including a parameter setter setting at least the rapid feed time constant, the speed gain, and the frequency band to be removed by the damping filter; and
the parameter setter being configured to execute a resonance frequency detection processing and an inertia estimation processing, the resonance frequency detection processing being executed by moving the movable rest having the object to be moved attached thereto and detecting a resonance frequency occurring on the moving device, the inertial estimation processing being executed by moving the movable rest having the object to be moved attached thereto and estimating an inertia acting on the moving device, and execute a processing of setting the frequency band to be removed by the damping filter and the speed gain based on the detected resonance frequency and a processing of setting the rapid feed time constant based on the estimated inertia.

According to this positioning apparatus, first, a position command is generated based on a target position by the position command generator; at least in the case of rapid feed movement, a position command corresponding to a rapid feed time constant is generated. Subsequently, a speed command is generated based on the position command and a position gain in the position controller, and then a torque command is generated based on the speed command and a speed gain in the speed controller. Thereafter, the generated torque command passes through the damping filter and thereby a component in a specific frequency band is removed, and then the torque command is input into the torque controller and a drive torque signal for the drive motor is generated based on the torque command and a torque gain in the torque controller. The drive motor is controlled in accordance with the drive torque signal; the thus controlled drive motor rotationally or linearly moves the movable rest having the object to be moved attached thereto.

In this positioning apparatus, the parameter setting method of the present disclosure is carried out appropriately by the parameter setter. That is, first, the parameter setter executes the resonance frequency detection processing in which the movable rest having the object to be moved attached thereto is moved and a resonance frequency occurring on the moving device is detected, and the inertia estimation processing in which the movable rest having the object to be moved attached thereto is moved and an inertial acting on the moving device is estimated.

Examples of the operation for moving the movable rest in the resonance frequency detection processing and the inertia estimation processing include an operation in which the movable rest is vibrated by generating a vibration generating signal with a constant frequency in the position command generator, an operation in which the movable rest is reciprocated by generating a signal for reciprocating the movable rest in the position command generator, and an operation in which the movable rest is repeatedly moved by generating a signal for repeatedly moving the movable rest by a predetermined distance or angle in one direction in the position command generator. Further, in each of these operations, the movement amount may be gradually increased, the moving speed may be gradually increased, or both the movement amount and the moving speed may be gradually increased.

Further, in the resonance frequency detection processing, for example, the FFT analysis is performed on a drive torque signal, which is an output signal from the torque controller, and a peak frequency of the drive torque signal is detected as a resonance frequency. Further, in the inertia estimation processing, for example, an inertial J acting on the moving device is estimated by the following equation:

J=(Tm−Tf)/ω,

where Tm is a drive torque output from the torque controller, Tf is a friction torque which is a pre-measured value or a design value, and w is a measured value of acceleration of the drive motor.

Further, the parameter setter sets the frequency band to be removed by the damping filter and the speed gain based on the detected resonance frequency and sets the rapid feed time constant based on the estimated inertia.

Thus, according to the parameter setter of the positioning apparatus and the parameter setting method, a resonance frequency occurring on the moving device is detected corresponding to an object to be moved attached to the movable rest and an inertia acting on the moving device is estimated corresponding to the object to be moved, and then the frequency band to be removed by the damping filter and the speed gain are set based on the detected resonance frequency and the rapid feed time constant is set based on the estimated inertia. Therefore, the control parameters can be set (reset) to proper control parameters corresponding to the object to be moved more quickly as compares with the conventional trial-and-error method.

Note that, in the parameter setter of the positioning apparatus and the parameter setting method, the control parameters may be set by the following procedure.

That is, first, the resonance frequency detection processing is executed and the frequency band to be removed by the damping filter is provisionally set based on the obtained resonance frequency,
subsequently, the inertial estimation processing is executed under the damping filter with the provisionally set frequency band to be removed, and the rapid feed time constant is set based on the obtained inertia, and
subsequently, the resonance frequency detection processing is executed under the set rapid feed time constant and the damping filter with the provisionally set frequency band to be removed, and, based on the obtained resonance frequency, the frequency band to be removed by the damping filter is definitively set and the speed gain is set.

In the case where the object to be moved is an object which is easily vibrated due to movement, vibration (external disturbance vibration) occurs on the moving device and a vibration frequency component of the external disturbance vibration is superimposed on signals of the control system when the inertia estimation processing is executed. Therefore, it is conceivable that the inertia J cannot be estimated accurately by the above equation using the maximum value of the drive torque output from the torque controller (Tₘₐₓ) and the measured value of the maximum acceleration of the drive motor (ωₘₐₓ) unless the vibration frequency component is removed by setting the frequency band to be removed by the damping filer to the vibration frequency.

Accordingly, the resonance frequency detection processing is executed first and the frequency band to be removed by the damping filter is provisionally set based on the obtained resonance frequency, and then the inertia estimation processing is executed using the damping filter with the provisionally set frequency band to be removed, which allows a vibration frequency component of external disturbance superimposed on signals of the control system to be removed properly by the damping filter when the inertia estimation processing is executed. This removal of a frequency component of external disturbance vibration allows the inertia to be estimated accurately and the accurately estimated inertia allows the rapid feed time constant to be set to a proper rapid feed time constant.

Subsequently, the resonance frequency detection processing is executed again under the proper rapid feed time constant and the damping filter with the provisionally set frequency band to be removed, whereby a more accurate resonance frequency is detected. Based on this accurate resonance frequency, the frequency band to be removed by the damping filter can be set to a more proper frequency band to be removed and the speed gain can be set to a proper speed gain.

Thus, according to this procedure, the control parameters can be set to proper control parameters even when the object to be moved is an object which is easily vibrated.

Alternatively, in the parameter setter of the positioning apparatus and the parameter setting method, the control parameters may be set by the following procedure.
That is, first, the inertia estimation processing is executed, and the rapid feed time constant is set based on the obtained inertia and the speed gain is provisionally set, and
subsequently, the resonance frequency detection processing is executed under the set rapid feed time constant and the provisionally set speed gain, and, based on the obtained resonance frequency, the frequency band to be removed by the damping filter is set and the speed gain is definitively set.

In the case where the object to be moved is an object which is hardly vibrated, external disturbance hardly occurs when the inertia estimation processing is executed; therefore, the inertia can be estimated accurately to some degree. Therefore, it is possible to execute the inertia estimation processing first and properly set the rapid feed time constant based on the obtained inertia, and further it is possible to provisionally set the speed gain to a proper speed gain.

Subsequently, the resonance frequency detection processing is executed using the set rapid feed time constant and the provisionally set speed gain, whereby an accurate resonance frequency can be detected. Based on the detected accurate resonance frequency, the frequency band to be removed by the damping filter can be set to a proper frequency band to be removed and the speed gain can be definitively set to a proper speed gain.

Thus, according to this procedure, the control parameters can be set properly when the object to be moved is an object which is hardly vibrated. Further, this procedure is simple because the inertia estimation processing and the resonance frequency detection processing are each executed once; therefore, the parameters can be set more quickly.

As described above, in the present disclosure, a resonance frequency occurring on the moving device is detected corresponding to an object to be moved attached to the movable rest and an inertia acting on the moving device is estimated corresponding to the object to be moved, and then the frequency band to be removed by the damping filter and the speed gain are set based on the detected resonance frequency and the rapid feed time constant is set based on the estimated inertia. Therefore, the control parameters can be set to proper control parameters corresponding to the object to be moved more quickly as compared with the conventional trial-and-error method.

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is a block diagram showing a positioning apparatus according to an embodiment of the present disclosure;

FIG. 2 is a schematic diagram showing a model of a rotary table to be controlled in the embodiment;

FIG. 3 is a flowchart showing a processing procedure in a parameter setter in the embodiment; and

FIG. 4 is a flowchart showing another processing procedure in the parameter setter in the embodiment.

### DETAILED DESCRIPTION

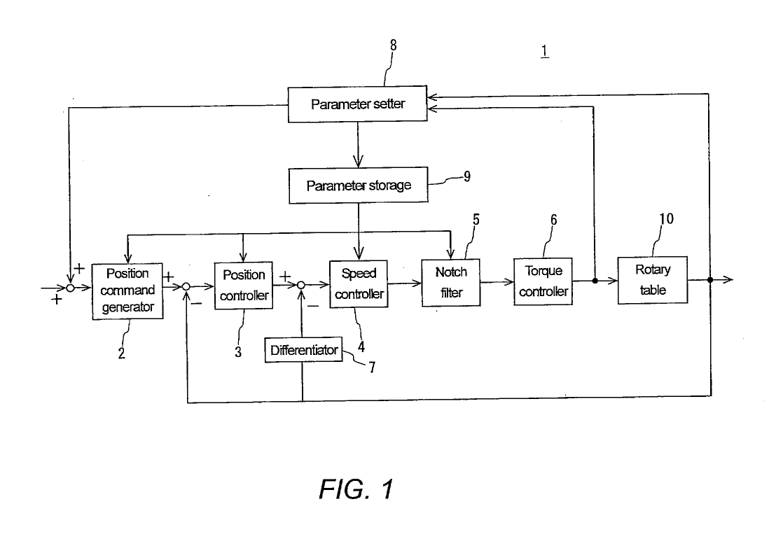

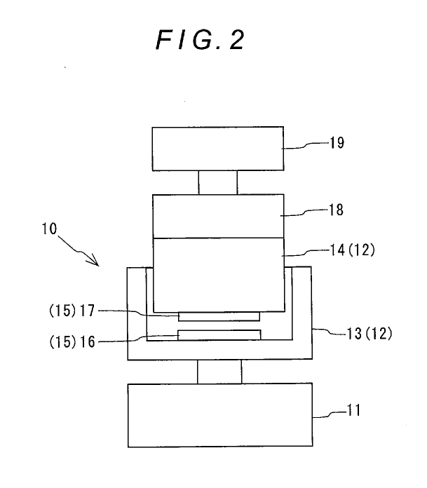

Hereinafter, a specific embodiment of the present disclosure will be described with reference to the drawings. FIG. 1 is a block diagram showing a positioning apparatus according to the embodiment and FIG. 2 is a schematic diagram showing a model of a rotary table to be controlled by the positioning apparatus. Note that FIG. 2 is a mere abstract conceptual diagram and does not show a specific structure of the rotary table.

First of all, prior to description of the positioning apparatus 1 in this embodiment, an overview of the rotary table to be controlled is given.

As shown in FIG. 2, the rotary table 10 in this embodiment includes a table base 11, a table 18 disposed on the table base 11 and provided to be rotatable about a vertical axis of rotation, and a motor 12 rotating the table 18 about the axis of rotation. The motor 12 is composed of a stator 13 fixed to the table base 11 and a rotor 14 arranged in the stator 13 in a state of being fixed to the table 18. Further, a rotational position of the rotor 14 with respect to the axis of rotation is detected by a position detector 15 composed of a part 17 provided on the lower surface of the rotor 14 and a part 16 provided on the stator 13 to face the part 17. Note that an appropriate workpiece 19 is attached to the table 18.

The positioning apparatus 1, as shown in FIG. 1, includes a position command generator 2, a position controller 3, a speed controller 4, a notch filter 5, a torque controller 6, a differentiator 7, a parameter setter 8, and a parameter storage 9.

The position command generator 2 performs a processing of generating a position command based on a target rotational position and a rotational speed, which are input therein, and outputting the generated position command. Note that, in the case where the input rotational speed is a rapid feed speed, the position command generator generates a position command corresponding to a rapid feed time constant and outputs the generated position command.

The position controller 3 performs a processing of generating a speed command based a deviation between the position command input from the position command generator 2 and a present position signal output from the position detector 15 of the rotary table 10 as well as a position gain and outputting the generated speed command.

The speed controller 4 performs a processing of generating a torque command based on a deviation between the speed command input from the position controller 3 and a present speed signal which is output from the position detector 15, differentiated by the differentiator 7, and then output from the differentiator 7 as well as a speed gain and outputting the generated torque command.

The torque command output from the speed controller 4 is input into the notch filter 5 and the notch filter 5 removes a component in a specific frequency band from the input torque command and then outputs the torque command.

The torque command output from the notch filter 5 is input into the torque controller 6 and the torque controller 6 performs a processing of generating a drive torque signal for the motor 12 based on the input torque command as well as a torque gain and outputting the generated drive torque signal.

Further, the parameter storage 9 is a functional unit storing therein control parameters used in the positioning apparatus 1. The rapid feed time constant, the position gain, the speed gain, the frequency band to be removed in the notch filter 5, and the torque gain are stored as control parameters in the parameter storage 9, and these control parameters are read out and used by the corresponding position command generator 2, position controller 3, speed controller 4, notch filter 5, and torque controller 6, respectively. Note that these control parameters can be stored into the parameter storage 9 from the outside and also can be updated by the parameter setter 8. Note that a specific processing in the parameter setter 8 will be described later.

Thus, according to the positioning apparatus 1, first, a position command is generated based on the target rotational position and the rotational speed in the position command generator 2; in the case where the rotational speed is a rapid feed speed, a position command corresponding to the rapid feed time constant is generated. Subsequently, a speed command is generated based on a deviation between the position command and the present position signal as well as the position gain in the position controller 3, and then a torque command is generated based on a deviation between the speed command and the present speed signal as well as the speed gain in the speed controller 4.

Subsequently, the generated torque command passes through the notch filter 5 and thereby a vibration component in a specific frequency band is removed from the torque command and then the torque command is input into the torque controller 6. A drive torque signal for the motor 12 is generated based on the torque command and the torque gain in the torque controller 6, and a current corresponding to the drive torque signal is supplied to the motor 12 and thereby the motor 12 is driven. Consequently, the table 18 is rotationally moved by the thus-controlled motor 12.

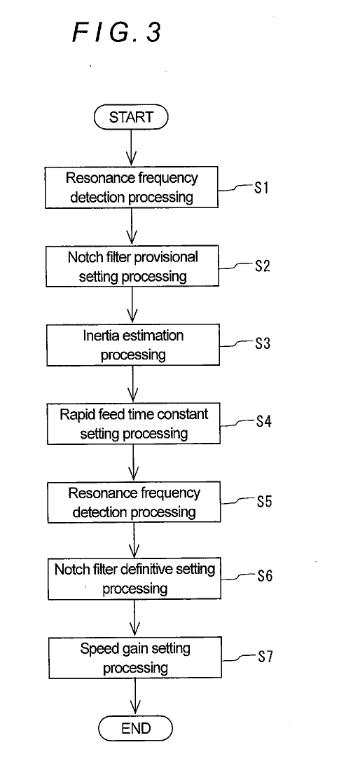

The parameter setter 8 is a functional unit that executes steps Si to S7 shown in FIG. 3; the parameter setter 8 starts when receiving a processing start signal that is input from the outside. Note that, in this example, the steps Si to S7 are executed in a state where a workpiece 19 is attached on the table 18.

Specifically, first, the parameter setter 8 executes a resonance frequency detection processing in the step S1. In this resonance frequency detection processing, the parameter setter 8 inputs a command to generate a position command vibrating with a constant frequency or a command to reciprocatingly rotate the rotary table 10 by a predetermined angle in normal and reverse directions into the position generator 2 or repeatedly inputs a command to rotate the rotary table 10 by a predetermined angle in one direction into the position command generator 2 to cause the rotary table 10 to perform a detecting operation, performs the FFT analysis on a drive torque signal output from the torque controller 6 during the detecting operation by the rotary table 10, and detects a peak frequency of the drive torque signal as a resonance frequency. Note that, in each of the detecting operations, the movement amount may be gradually increased, the moving speed may be gradually increased, or both the movement amount and the moving speed may be gradually increased.

After a resonance frequency is detected in this way, the parameter setter 8 provisionally sets the frequency band to be removed, which is used in the notch filter 5, based on the detected resonance frequency, and stores data for the provisionally set frequency band to be removed into the parameter storage 9, that is, updates data stored in the parameter storage 9 with the data for the provisionally set frequency band to be removed (step S2).

Next, the parameter setter 8 executes an inertia estimation processing (step S3). That is, similarly to the resonance frequency detection processing, first, the parameter setter 8 inputs a command to generate a position command vibrating with a constant frequency or a command to reciprocatingly rotate the rotary table 10 by a predetermined angle in the normal and reverse directions into the position command generator 2 or repeatedly inputs a command to rotate the rotary table 10 by a predetermined angle in one direction into the position command generator 2 to cause the rotary table 10 to perform a detecting operation. Note that, in control of the detecting operation by the rotary table 10, the frequency band to be removed set in the step S2 is used in the notch filter 5. Further, also in each of these detecting operations, the movement amount may be gradually increased, the moving speed may be gradually increased, or both the movement amount and the moving speed may be gradually increased.

Further, the parameter setter 8 estimates an inertia J acting on the rotary table 10 by the following equation based on a drive torque signal output from the torque controller 6 during the detecting operation by the rotary table 10 (Tₘ), an angular acceleration of the motor 12 measured by the position detector 15 (ω), and a friction torque measured in advance or obtained as a design value (T_{f}). Note that the inertia J is caused by the table 18 and the workpiece 9.

J=(Tm−Tf)/ω

Thereafter, the parameter setter 8 sets the rapid feed time constant based on the thus estimated inertia J, and stores data for the set rapid feed time constant into the parameter storage 9, that is, updates the data stored in the parameter storage 9 with the data for the set rapid feed time constant (step S4).

Next, the parameter setter 8 executes the resonance frequency detection processing again (step S5). This resonance frequency detection processing is the same as the resonance frequency detection processing executed in the step S1, except that, in control of the detecting operation by the rotary table 10, the rapid feed time constant set in the step S4 is used in the position command generator 2.

Next, the parameter setter 8 definitively sets the frequency band to be removed, which is used in the notch filter 5, based on the resonance frequency detected in the step S5, and stores data for the set frequency band to be removed into the parameter storage 9, that is, updates the data stored in the parameter storage 9 with the data for the set frequency band to be removed (step S6). Further, the parameter setter 8 sets the speed gain, which is used in the speed controller 4, based on the resonance frequency detected in the step S5, and stores data for the set speed gain into the parameter storage 9, that is, updates the data stored in the parameter storage 9 with the data for the set speed gain (step S7). Thereafter, the parameter setting processing ends.

Thus, according to the parameter setter 8 in this example, the above-described parameter setting processing (that is, the resonance frequency detection processing (step Si), the notch filter provisional setting processing (step S2), the inertia estimation processing (step S3), the rapid feed time constant setting processing (step S4), the resonance frequency detection processing (step S5), the notch filter setting processing (step S6), and the speed gain setting processing (step S7)) is executed in a state where the workpiece 19 is attached on the table 18, which allows the control parameters to be set to proper control parameters corresponding to the workpiece 19. Further, the control parameters can be set (reset) more quickly as compared with the conventional trial-and-error method.

By the way, in the case where the workpiece 19 is a workpiece which is easily vibrated when being rotated, e.g., a workpiece having a very thin thickness, when the inertia estimation processing (step S3) is executed, vibration (external disturbance vibration) occurs on the rotary table 10 and a vibration frequency component of the external disturbance vibration is superimposed on signals of the control system (the position controller 3, the speed controller 4, the torque controller 6, etc.). Therefore, there is concern that t the above equation using a drive torque T. output from the torque controller 6 and a measured value ω of the acceleration of the motor 12 might not be able to accurately estimate the inertia J unless the vibration frequency component is removed by setting the frequency band to be removed by the notch filter 5 to the vibration frequency.

Accordingly, in this example, the resonance frequency detection processing (step S1) is executed first and the frequency band to be removed by the notch filter 5 is provisionally set based on the obtained resonance frequency (step S2), and then the inertia estimation processing (step S3) is executed under the notch filter 5 with the provisionally set frequency band to be removed. Therefore, when the inertia estimation processing (step S3) is executed, a vibration frequency component of external disturbance superimposed on signals of the control system can be removed by the notch filter 5. This removal of a frequency component of external disturbance allows the inertia J to be estimated accurately and the accurately estimated inertia J allows the rapid feed time constant to be set properly (step S4).

Subsequently, the resonance frequency detection processing is executed again under the properly set rapid feed time constant (step S5), whereby a more accurate resonance frequency is detected. Based on this accurate resonance frequency, the frequency band to be removed by the notch filter 5 can be set to a more proper frequency band to be removed and the speed gain can be set to a proper speed gain.

Thus, according to the positioning apparatus 1 including the parameter setter 8 in this example, the control parameters can be set to proper control parameters quickly even when the workpiece 19 is a workpiece which is easily vibrated.

A specific embodiment of the present disclosure has been described above; however, the present disclosure is not limited thereto and can be implemented in other modes.

For example, the processing of definitively setting the frequency band to be removed by the notch filter 5 (step S6) and the processing of setting the speed gain (step S7) may be executed in reverse order.

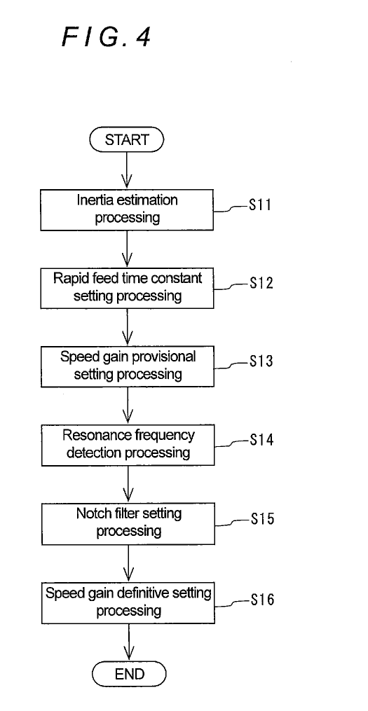

Further, in the case where the workpiece 19 is a workpiece which is hardly vibrated, the parameter setter 8 may be configured to execute a processing procedure as shown in FIG. 4.

That is, first, the parameter setter 8 executes an inertia estimation processing similar to that in the step S3 of the foregoing example (step S11). Thereafter, based on the obtained inertia, the parameter setter 8 sets the rapid feed time constant in a manner similar to that in the step S4 of the foregoing example (step S12) and provisionally sets the speed gain (step S13).

Subsequently, the parameter setter 8 executes a resonance frequency detection processing similar to that in the steps S1 and S5 of the foregoing example under the set rapid feed time constant and the provisionally set speed gain (step S14). Based on the obtained resonance frequency, the parameter setter 8 sets the resonance frequency to be removed by the notch filter 5 in a manner similar to that in the step S6 of the foregoing example (step S15) and definitively sets the speed gain in a manner similar to that in the step S7 of the foregoing example (step S16).

In the case where the workpiece 19 is a workpiece which has a high rigidity and is hardly vibrated, external disturbance hardly occurs when the inertia estimation processing (step S11) is executed; therefore, the inertia can be estimated accurately to some degree. Therefore, the inertia estimation processing (step S11) can be executed first, and the rapid feed time constant can be set to a proper rapid feed time constant based on the obtained inertia (step S12) and the speed gain can be provisionally set to a proper speed gain (step S13).

Subsequently, the resonance frequency detection processing is executed using the set rapid feed time constant and the provisionally set speed gain (step S14), whereby the resonance frequency can be detected accurately. Based on this accurate resonance frequency, the frequency band to be removed by the notch filter 5 can be set to a proper frequency band to be removed (step S15) and the speed gain can be definitively set to a proper speed gain (step S16).

As described above, according to the procedure shown in FIG. 4, the control parameters can be set properly in the case where the workpiece 19 is a workpiece which is hardly vibrated. Further, as compared with the procedure shown in FIG. 3, the procedure shown in FIG. 4 is simpler because the inertia estimation processing (step S11) and the resonance frequency detection processing (step S14) are each executed once; therefore, the parameters can be set more quickly.

Note that, also in the example shown in FIG. 4, the processing of setting the rapid feed time constant (step S12) and the processing of provisionally setting the speed gain (step S13) may be executed in reverse order, and the processing of setting the frequency band to be removed by the notch filter 5 (step S15) and the processing of definitively setting the speed gain (step S16) also may be executed in reverse order.

Moreover, in the above embodiment, the rotary table 10 is given as an example of the object to be controlled by the positioning apparatus 1; however, the moving device to be controlled is not limited thereto and may be, for example, a moving device linearly moving an object to be moved.

What is claimed is:

1. A parameter setting method for setting control parameters for a positioning apparatus positioning a movable rest for attaching an object to be moved thereto at a commanded target position by controlling a drive motor of a moving device rotationally or linearly moving the movable rest, the control parameters including at least control parameters for a rapid feed time constant, a speed gain, and a frequency band to be removed by a damping filter, comprising:
executing a resonance frequency detection processing and an inertia estimation processing, the resonance frequency detection processing being executed by moving the movable rest having the object to be moved attached thereto and detecting a resonance frequency occurring on the moving device, the inertia estimation processing being executed by moving the movable rest having the object to be moved attached thereto and estimating an inertia acting on the moving device; and
setting the frequency band to be removed by the damping filter and the speed gain based on the detected resonance frequency and setting the rapid feed time constant based on the estimated inertia.

2. The parameter setting method according to claim 1, wherein:
the resonance frequency detection processing is executed first and the frequency band to be removed by the damping filter is provisionally set based on the detected resonance frequency;
subsequently, the inertial estimation processing is executed under the damping filter with the provisionally set frequency band to be removed and the rapid feed time constant is set based on the estimated inertia; and
subsequently, the resonance frequency detection processing is executed under the set rapid feed time constant and the damping filter with the provisionally set frequency band to be removed, and, based on the detected resonance frequency, the frequency band to be removed by the damping filter is definitively set and the speed gain is set.

3. The parameter setting method according to claim 1, wherein:
the inertia estimation processing is executed first, and the rapid feed time constant is set based on the estimated inertia and the speed gain is provisionally set; and
subsequently, the resonance frequency detection processing is executed under the set rapid feed time constant and the provisionally set speed gain, and, based on the detected resonance frequency, the frequency band to be removed by the damping filter is set and the speed gain is definitively set.

4. A positioning apparatus positioning a movable rest for attaching an object to be moved thereto at a commanded target position by controlling a drive motor of a moving device rotationally or linearly moving the movable rest, comprising:
a position command generator generating a position command based on the target position and outputting the generated position command and, at least in a case of rapid feed movement, generating a position command corresponding to a rapid feed time constant and outputting the generated position command;
a position controller receiving input of the position command output from the position command generator, and generating a speed command based on the input position command and a position gain and outputting the generated speed command;
a speed controller receiving input of the speed command output from the position controller, and generating a torque command based on the input speed command and a speed gain and outputting the generated torque command;
a damping filter receiving input of the torque command output from the speed controller, and removing a component in a specific frequency band from the input torque command and then outputting the torque command;
a torque controller receiving input of the torque command output from the damping filter, and generating a drive torque signal for the drive motor based on the input torque command and a torque gain and outputting the generated drive torque signal; and
a parameter setter setting at least the rapid feed time constant, the speed gain, and the frequency band to be removed by the damping filter;
the parameter setter being configured to execute a resonance frequency detection processing and an inertia estimation processing, the resonance frequency detection processing being executed by moving the movable rest having the object to be moved attached thereto and detecting a resonance frequency occurring on the moving device, the inertial estimation processing being executed by moving the movable rest having the object to be moved attached thereto and estimating an inertia acting on the moving device, and execute a processing of setting the frequency band to be removed by the damping filter and the speed gain based on the detected resonance frequency and a processing of setting the rapid feed time constant based on the estimated inertia.

5. The positioning apparatus according to claim 4, wherein:
the parameter setter is configured to execute the resonance frequency detection processing first and execute a processing of provisionally setting the frequency band to be removed by the damping filter based on the detected resonance frequency;
subsequently, execute the inertia estimation processing under the damping filter with the provisionally set the frequency band to be removed and execute the processing of setting the rapid feed time constant based on the estimated inertia; and
subsequently, execute the resonance frequency detection processing under the set rapid feed time constant and the damping filter with the provisionally set frequency band to be removed and, based on the detected resonance frequency, execute a processing of definitively setting the frequency band to be removed by the damping filter and a processing of setting the speed gain.

6. The positioning apparatus according to claim 4, wherein:
the parameter setter is configured to execute the inertia estimation processing first and execute the processing of setting the rapid feed time constant based on the estimated inertia and a processing of provisionally setting the speed gain; and
subsequently, execute the resonance frequency detection processing under the set rapid feed time constant and the provisionally set speed gain and, based on the detected resonance frequency, execute a processing of setting the frequency band to be removed by the damping filter and a processing of definitively setting the speed gain.
